(19) United States
(12) Patent Application Publication
(10) Pub. No.: US 2024/0430116 A1
(43) Pub. Date: Dec. 26, 2024

(54) SYSTEMS AND METHODS FOR VIDEO CONFERENCE ANALYSIS

(71) Applicant: Orbit Group Partners Inc., Thornhill (CA)

(72) Inventors: Robert Owen Hahn, Thornhill (CA); Alberico Grossi, Thornhill (CA); Daniel Yves Lepage, Thornhill (CA); David Janssen, Thornhill (CA); Jamal Kelmar Edey, Thornhill (CA)

(21) Appl. No.: 18/752,643

(22) Filed: Jun. 24, 2024

Related U.S. Application Data
(60) Provisional application No. 63/523,348, filed on Jun. 26, 2023.

(51) Int. Cl. H04L 12/18; G06F 40/205; G06Q 10/0639; H04M 3/51

(52) U.S. Cl. CPC H04L 12/1831; G06F 40/205; G06Q 10/06393; H04L 12/1822; H04M 3/5175; H04M 2203/401; H04M 2203/402; H04M 2203/558

(57) ABSTRACT

A system for video conference and/or chat analysis. The system has a system server which interfaces between a coaching server and a video conferencing, and/or chat server. The coaching server contains training and coaching data leveraged to facilitate human resource performance improvement activities in resource intensive environments such as human resources, contact centers, or back-office environments. The communication server hosts video conferences and chat sessions respectively. The system server initiates video conferences and/or chat sessions on the communication server based on information received from the coaching server. The system server retrieves a transcript from the communication server after a video conference or a chat transcript during active chat session, parses and processes the video and/or chat transcript and enters the processed transcript into the coaching server.

### REFERENCE TO RELATED APPLICATIONS

This application claims the benefit of pending application Application No. 63/523,348 filed on Jun. 26, 2023 entitled Systems and Methods for Video Conference Analysis.

### BACKGROUND OF THE INVENTION

Certain aspects of the present disclosure generally relate to a system and method for conducting analysis on a video conference, specifically in the context of video conference calls for ongoing training for performance management and improvement activities.

The landscape of the workplace has significantly shifted during and after the COVID-19 pandemic. Leveraging the increased interconnectivity and accessibility provided by the internet, more workers than ever now work remotely, in either remote or home offices, for example. In other instances, increased interconnectivity and accessibility has allowed for workers to work collaboratively across large geographical areas. Remote or distance working arrangements allow employers the benefit from access to a wider geographic pool of staff, while providing workers with improved flexibility. Examples of these Crucial technologies enabling this increased interconnectivity and accessibility are video conferencing, Chat and email, allowing workers to connect and communicate with colleagues efficiently in real-time across the globe. However, the increased physical separation caused by remote work creates challenges for certain positions, such as those requiring ongoing performance monitoring, training, or coaching. It is desired to further leverage capabilities available due to advances in video conferencing, chat, and speech-recognition technology and AI to assist remote performance monitoring, training, and/or coaching. Video conferencing and/or chat is also increasingly being used for meetings, training, and coaching even in single office environments, and it is also desired to leverage capabilities available due to advances in video conferencing, chat, speech-recognition and AI technology to assist performance monitoring, training, and/or coaching in meetings over video conference.

### SUMMARY OF THE INVENTION

Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the present disclosure provides a system for video conference and/or chat analysis to provide improved performance monitoring, training and/or coaching in meetings over video conference over existing systems.

### BRIEF DESCRIPTION OF DRAWINGS

FIG. 1 illustrates an exemplary system for video conference analysis according to one aspect of the present disclosure.

FIG. 2 is a flow chart diagram showing the components of an exemplary system for video conference analysis.

FIG. 3 is a flow chart diagram showing the pre-conference operation of an exemplary system video conference analysis according to one aspect of the present disclosure.

FIG. 4 is a flow chart diagram showing the post-conference operation of an exemplary system video conference analysis according to one aspect of the present disclosure.

FIG. 5 is a flow chart diagram showing the integration operation of an exemplary system video conference analysis according to one aspect of the present disclosure.

FIG. 6 illustrates an exemplary method for video conference analysis.

FIG. 7 is a flow chart diagram showing the integration operation of an exemplary system for chat analysis according to one aspect of the present disclosure.

FIG. 8 is a flow chart diagram showing the integration operation of an exemplary system for chat analysis according to one aspect of the present disclosure.

FIG. 9 is a flow chart diagram showing the integration operation of an exemplary system for chat analysis according to one aspect of the present disclosure.

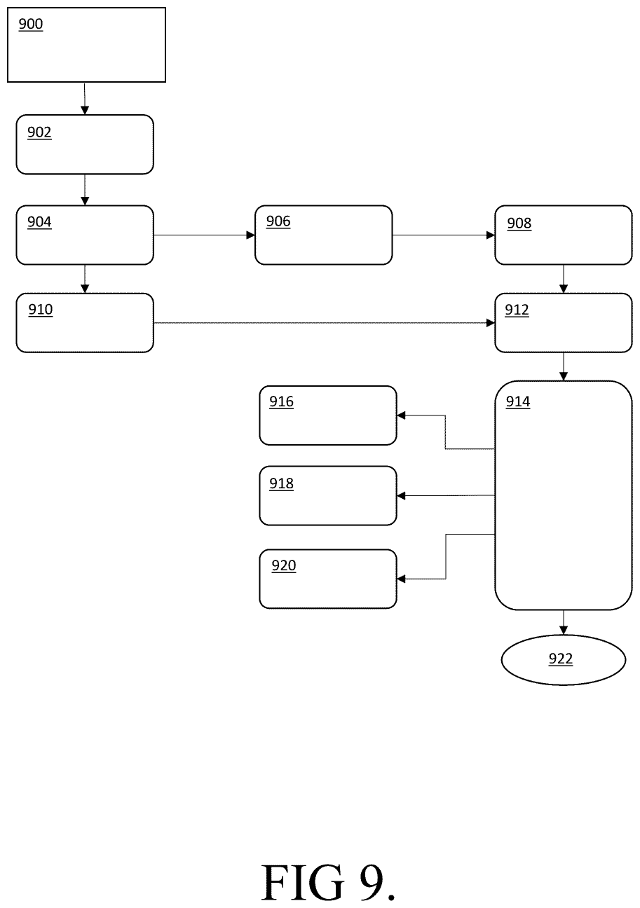

### DESCRIPTION OF THE INVENTION

Various aspects of the novel systems, apparatuses, and methods are described more fully hereinafter with reference to the accompanying drawings. The teachings disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus can be implemented, or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. Any aspect disclosed herein can be embodied by one or more elements of a claim.

Although aspects are described herein, many variations and permutations of these aspects fall within the scope of the disclosure. Although some benefits and advantages of the preferred aspects are mentioned, the scope of the disclosure is not intended to be limited to benefits, uses, or objectives. The detailed description and drawings are merely illustrative of the disclosure rather than limiting.

As described herein, “coaching” may refer to, generally and without limitation, a variety of activities including training, personal development planning, generating coaching plans, and key performance indicator alignment, for example. In some embodiments, coaching may refer to advising, counselling, consulting, teaching or education, professional development, or any other interpersonal knowledge or skill transfer activity and behavioral proficiency.

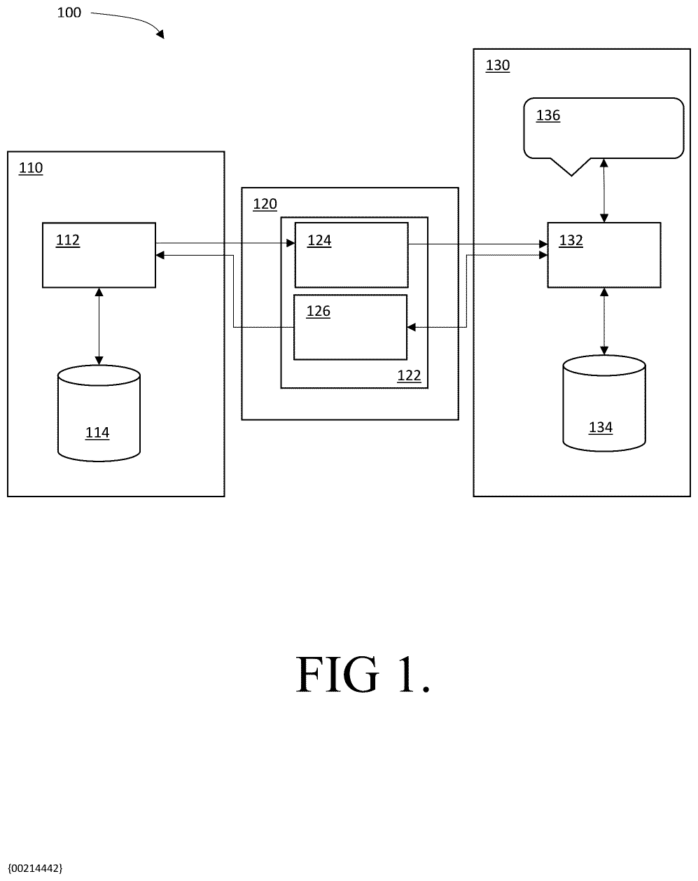

FIG. 1 is an illustration an exemplary system 100 according to one aspect of the present disclosure. The system 100 includes a coaching server 110, a system server 120, and a communication server 130. The coaching server 110 contains coaching data 114 regarding coaching of workers. In an exemplary embodiment, the coaching server 110 may contain coaching data 114 such as names of workers, key performance indices, observations, evaluations, coaching goals, coaching plans, coaching commitments, coaching narrative and other coaching metrics associated with each worker, and a coaching staff member (coach) assigned to each worker, for example, which, in a specific embodiment, may be leveraged by the coaching server 110 to facilitate human resource performance improvement activities in resource intensive environments such as office environments, human resources, contact centers, retail or back-office environments. The coaching server 110 may have a coaching server processor 112 for processing coaching data 114. In some embodiments, the communication server 130 is adapted for hosting communications such as video conferences 136 between users. In other embodiments, the communication server may be adapted for other forms of communication such as instant messaging or chat, for example. The communication server 130 may have user data 134 associated with various users, and a conferencing processor 132 for hosting video conferences 136 between users, for example.

The system server 120 has a processor 122 configured to interface between the coaching server 110 and the communication server 130. In an exemplary embodiment, the system processor 122 may be configured to perform a first interfacing task 124. In some embodiments, the first interfacing task 124 may comprise retrieving information from the coaching server 110, such as through an application programming interface (API) of the coaching server 110, and engaging with an application programming interface (API) of the communication server 130 to initiate an event. In a particular example, the system processor 122 of the system server 120 may receive information from the coaching server 110 identifying users, such as names and roles of said users, which should join a video conference call for coaching purposes. In such an embodiment, the first interfacing task 124 may comprise receiving said information and communicating with the communication server 130 by providing the associated identification necessary for the conferencing server to access appropriate user data 134 and initiate a video conference 136 between the users, for example.

In yet another exemplary embodiment, the processor 122 of the system server 120 may be configured to perform a second interfacing task 126. In some embodiments, the second interfacing task 126 may comprise retrieving information from the communication server 130, such as through an application programming interface (API) of the communication server 130, processing the information, and providing processed information to the coaching server 110, such as through an application programing interface (API) of the coaching server 100. In a particular example, the system processor 122 of the system server 120 may communicate with the conferencing processor 132 of the communication server 130 to monitor for termination of a video conference 136. The system processor 122 may then send a request to the conferencing processor 132 to retrieve conference information from the conferencing server 130, such as user data 134 including a transcript for the video conference 136, for example. In such an embodiment, the second interfacing task 126 may comprise requesting and receiving said conference information, and processing said conference information, such as by extracting text from the transcript, assigning identity information to the transcript, and formatting the information in a manner suitable for delivery to the coaching server 110, for example. In further embodiments, processing may involve other steps, such as conducting analysis on the extracted text, which may be carried out by a user, or autonomously by the system processor 122, through the use of artificial intelligence (AI) such as a neural network trained to sort or process text transcripts, for example. In a particular embodiment, the processing may comprise identifying specific statements within the transcript, such as observations, assessments or commitments, which are then sent to the coaching server 110 and stored in the coaching data 114, and may trigger a subsequent video conference through the system at a later date, for example.

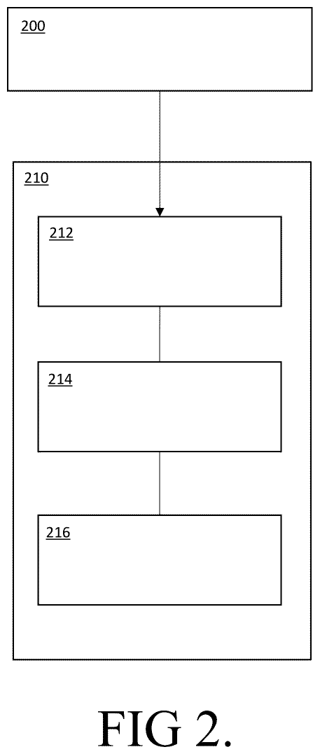

FIGS. 2-5 show details of specific steps of a specific, exemplary, embodiment of the system, wherein the coaching server 110 is a server for a coaching management software designed for the ongoing training and coaching of contact center staff, and the communication server 130 is a server for Microsoft Teams®. In other embodiments, the coaching server 110 may be a database or software server designed for any other field or industry with ongoing training requirements. In yet other embodiments, the communication server 130 may be a server for Zoom®, Cisco WebEx®, or any other video conferencing platform, for example.

In one example situation of the above specific exemplary embodiment, the coaching management software is designed for the ongoing training and coaching of contact center staff, and identifies that an employee of the contact center is underperforming according certain key performance indices (KPI), and recommends that a coach should meet with said employee to provide coaching. As the coach and the employee are not co-located, coaching is to be provided through video conferencing, namely, over a Microsoft Teams® call. The coaching server 110 may provide a notification or alert to the employee and/or the coach, and may provide instructions to the system server 120 to initiate a video conference over a Microsoft Teams®. The instructions may be initiated manually, such as by the coach interacting with a button on the software running on the coaching server 110, which then sends instructions to the system server 120, or in other embodiments, the instructions may be initiated automatically based on schedules of the coach and the employee, for example. The instructions contain contextual information regarding the coaching activity to be performed, such as the topic to be discussed during the video conference. As shown in FIG. 2, the system server 120 receives, through a front-end application, the instructions 200 to initiate a video conference through use of the novel system 210. A processor of the system server 120 communicates with the communication server 130 through the front-end application 212, and provides the required credentials to access functionality on the video conferencing sever 130. The system server 120 then launches a bot application interfacing with the communication server 130, which initiates a video conference 136, creating a call having a title based on the title related to the contextual information in the instructions, and inviting both the coach and the employee to join said video conference 136. The system server 120, through the bot application 216, also notifies the coach and the employee to enable recording of the transcript for the video conference 136. When all required participants, namely, both the coach and the employee, have joined the video conference, the system server 120 withdraws the bot application from the video conference, and monitors, through a back-end application 212, to determine when the video conference 136 concludes.

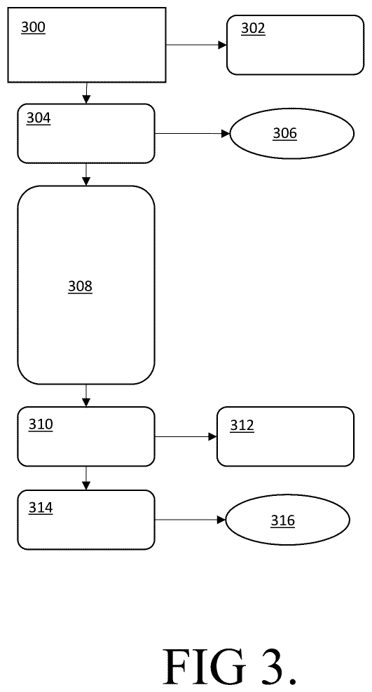

As shown in FIG. 3, initiating the call 300 causes a notification 302 to be sent to the participants, while simultaneously causes the front-end application to open and manage sign-in 304 to a profile on the communication server 130. A user may either cancel 306, thereby terminating the process, or sign in 308, which then causes a series of steps to be carried out. In this example, the video conferencing software is Microsoft Teams®, and the system determines and manages validation of the participants' Microsoft Teams® profiles, retrieves information from the coaching server 100, validates and acquires electronic mail addresses and tokens from Microsoft to establish credentials, uses said credentials to initiate a Teams® call, uses the electronic mail addresses to retrieve participant's contact information, and populates the meeting with the appropriate participants and the bot application. Once the participants are determined, the system then sends invitations 310 to each participant. Each participant receives a notification 312 from Microsoft Teams® to join the meeting, while the back-end application monitors 314 the call with all participants, until the call ends 316.

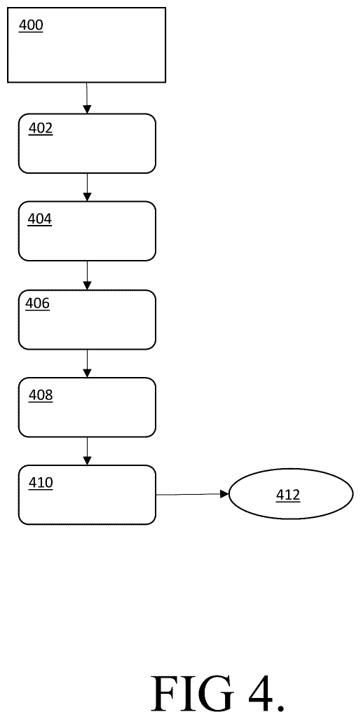

As shown in FIG. 4, when the video conference 136 concludes 400, the system server 120 is notified by its back-end application and thereby determines that the meeting has ended 402, and the back-end application requests and receives 404, from the communication server 130 a transcript file. In this example, the transcript file is a VTT file generated by Microsoft Teams®. The back-end application of the system server 120 parses the VTT file to extract the raw text. The back-end application of the system server 120 then processes the text 406 by determining which participant of the video conference communicated the contents of the text during the actual video conference, and assigns an identifier and time stamp associated with each segment of text, thereby aligning each segment of conversation with a participant-either the coach, or the employee. The back-end application of the system server 120 may also engage the front-end application to enable a user, such as the coach, through a guided user interface (GUI) to identify certain segments each conversation with a participant, such as the employee, as having particularly important information. For example, the coach may wish to identify and flag specific points discussed during the video conference, such as promises, commitments, or challenges, which may assist the coach and the employee in achieving their respective goals. In yet other embodiments, the back-end application of the system server 120 may have artificial intelligence (AI) integration, such as a pre-trained neural network, which may be adapted to identify certain segments each conversation as having particularly important information. The AI may then present its output to the coach in collaborative operation, for example, or may operate entirely autonomously to reduce coaching workload. The back-end application of the system server 120 may also then format the transcript into a form which is readable by the coaching server 110, such as according to the format required to be entered into a database on the coaching server 110, for example. In other embodiments, the coaching server 110 may have its own software which can further format or process the transcript upon receipt from the back-end application of the system server 120. The back-end application of the system server 120 then sends 408 the processed transcript to the coaching server 110 for storage onto a database. The back-end application of the system server 120 creates an identifier for the transcript based on the contextual information regarding the coaching activity to be performed, and records further identifying information for the transcript such as the date, time, and names of the participants, for example. The back-end application of the system server 120 may also associate 410 a commitment focus to the transcript, based on the contextual information and/or parsed information, such as the topic discussed during the video conference. In some embodiments, the contextual information is simply the contextual information received by the system server 120 from the coaching server 110 prior to the meeting. In other embodiments, the contextual information may be updated based on the processing of the transcript. For example, as described above, specific points discussed during the video conference, such as promises, commitments, or challenges may be identified by a user, or autonomously by the back-end application, and the contextual information may be updated to reflect these identified points. In one illustrative example, a meeting may be launched between the coach and the employee over deficiencies in the KPI. The coach and the employee discuss various steps to potentially improve performance in the future, and agree to a change to how the employee conducts calls moving forward. Initially, the contextual information may simply reflect the deficiency in the KPI, whereas when the transcript is processed, the specific statement where the employee agrees to and commits to the change moving forward can be identified, and the contextual information can be updated to reflect the identified commitment, and the transcript can be saved onto the database of the coaching server 110 with said updated contextual information.

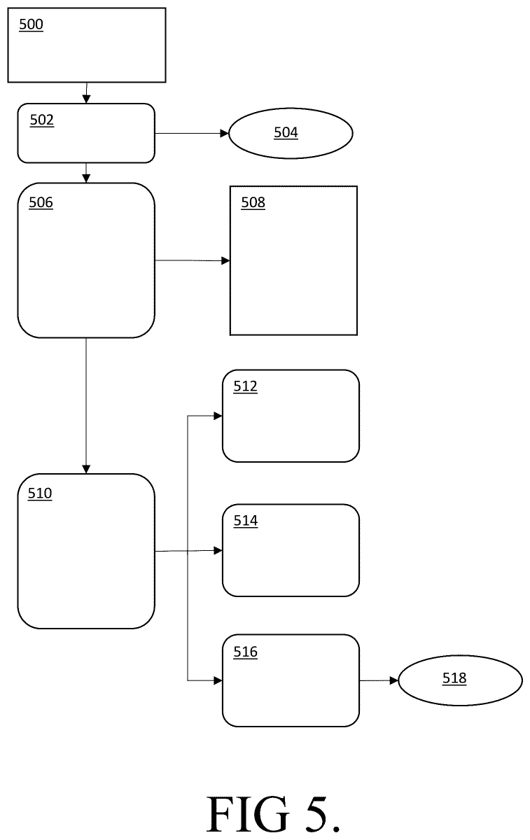

The back-end application of the system server 120 forwards the processed transcript to a database of the coaching server 110. Referring to FIG. 5, the back-end application may engage the front-end application to provide a GUI for a user, such as the coach, to assist with entering information in the processed transcript stored on the database of the coaching server 110 into a coaching management software hosted on the coaching server 110. In an exemplary embodiment of this process, the front-end application may receive notification 500 of a new transcript to be used in coaching. The front-end application may then provide a GUI 502 to a user, such as a notification pop-up, prompting the user to view the transcript which proceed 506, or to stay on the current window 504, which terminates the process. The front-end application of the system server 120 may retrieve, from the processed transcript, data 508 comprising the title/ID of the conversation, the date, the focus or purpose of the video conference, a description of the conference based on contextual information, the identity of the participants, and the full set of quotes, with speakers and time stamps, reflecting the content of the video conference. The front-end application may additionally have a number of features 510 for the user. The front-end application of the system server 120 may provide which allow the user to edit or add 512 to the information as described above before entry into the coaching management software such as the title, description, focus, or extra behavioral foci, the changes of which are communicated to the back-end application and then re-sent to the database of the coaching server 110 for storage, such that the database remains up to date. Through the front-end application, the user may also be provided with a GUI having tools for navigating the processed transcript, such as conversation filters 514 comprising browsing through the transcript by timestamp using a slider, filtering the conversation based on participants with toggle buttons, or searching for particular keywords in the conversation via a search bar, for example. The user may also, through the front-end application, append notes or observations 516 separate from, but associated with, the processed transcript. Finally, the processed transcript, as amended and further annotated by the user, is entered into the coaching management software 518. In some embodiments, the coaching management software may then use the additional information in the processed, amended, and annotated transcript and associated data in its function, such as to recommend further video conferences for further coaching, for example.

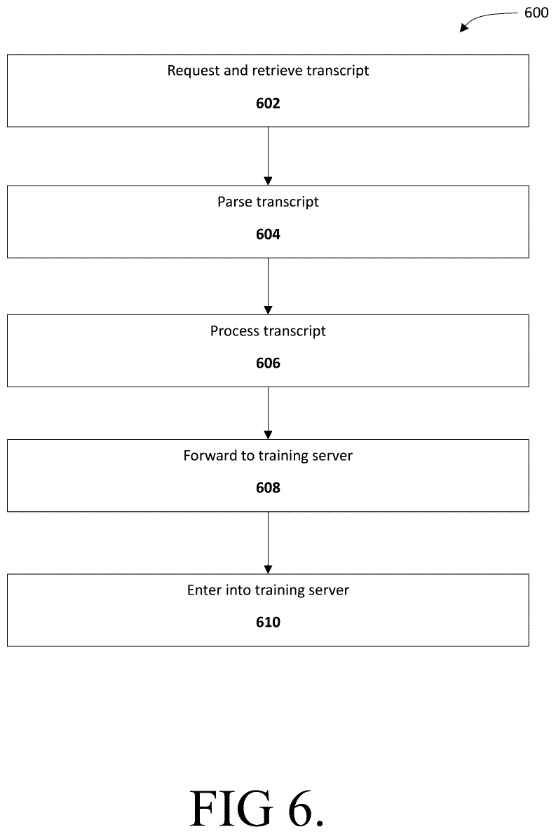

Referring to FIG. 6, a method for video conferencing analysis is shown generally at 600. The method 600 comprises a request and retrieval step 602, a parsing step 604, and processing step 606, a forwarding step 608, and an entering step 610. The request and retrieval step 602 comprises monitoring, by a processor, for the termination of a video conference on a video conferencing platform through an application programming interface (API) hook, requesting, by a processor, a file containing a transcript of the video conference, and receiving, by a processor, the file containing the transcript. The parsing step 604 comprises parsing, by a processor, the file containing the transcript to extract transcript information from the file. The processing step 606 comprises conducting, by the processor, further processing of the transcript information such that the transcript information is in a format comprehensible by a coaching server. The forwarding step 608 comprises forwarding processed transcript information to a coaching server. The entering step involves entering the processed transcript information into the coaching server.

In an exemplary embodiment, the request and retrieval step 602 involves monitoring, by a processor, through an API hook, for the end of a video conference call between two or more participants on a video conferencing platform such as Microsoft Teams®. The processor then sends a request to the communication server to retrieve a raw data file containing a transcript of conversations between the participants of the video conference. The parsing step 604 involves the processor extracting the transcript of the conversations and formatting said transcript for further processing. The parsing step 604 involves locating identifiers for participants in the transcript, dividing the transcript into fragments and assigning time stamps to each of said fragments. The processing step 606 may involve aligning, by a processor, portions of the transcript information according to participant in the video conference, appending, by a processor, time stamps to each portion of the transcript information, and/or analyzing, by a processor, the transcript information to identify information according to predetermined criteria such as specific words associated with coaching objectives, for example. In some further embodiments, the processor for analyzing the transcript information may be an artificial intelligence (AI), such as a pre-trained neural network, may be used to identify certain portions of the transcript based on content and/or context which are of particular importance. In a specific exemplary embodiment, the processing step 606 may involve identifying actions, such as commitments, promises, observations, assessments or actionable items communicated by participants of the video conference. In an embodiment, the purpose of processing step 606 is to convert the raw, parsed transcript into a processed transcript wherein each segment of conversation in the video conference is time stamped and associated with a participant, such that conversations within the video conference can be presented to a user in a human-accessible format, as well as in a computer-readable format for entry into a database of a coaching server, for example. The forwarding step 608 then involves sending the processed transcript, including said actions, to a coaching server, and the entering step 610 may involve entering the transcript into the coaching server. In one embodiment, sending the processed transcript involves sending the transcript with modifications embedded within the transcript. In other embodiments, a separate document containing the modifications is sent in addition to the transcript, such that a receiving software of a coaching server may apply the modifications and processing to the transcript. The coaching server may be configured to receive and/or act on the processed transcript. The entering step 610 may involve entering the processed transcript, or identified actions into forms, such as an action form, associated with one or more of the participants, such that said one or more participants can refer to said commitments, and an instructor, coach, or trainer associated with said one or more participants can reference the action. The coaching server may then use the entered transcript or actions in monitoring of coaching outcomes, for example.

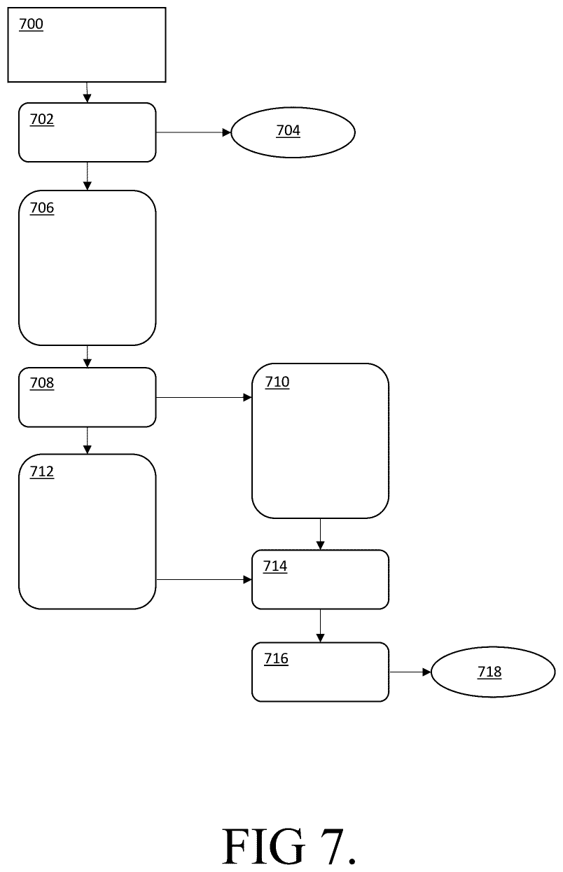

In further embodiments, the communication server 130 may include an instant messaging server, adapted for transmitting messages in text form between users in a chat. In such an embodiment, the system 100 may also facilitate integration of the chat from the communication server 130 with the coaching server 110 through the system server 120. As shown in FIG. 7, a user may interact 700 with an element on the coaching software on the coaching server 110, which then causes the front-end application of the system server 120 to communicate with the communication server 130 to launch 702 sign-in validation. If the sign-in is cancelled, the process ends 704. Otherwise, the front-end application carries out steps 706, including determining and managing validation tokens as stored on the coaching server 110, validating the tokens and acquiring authorization tokens from the communication server 130, and using the authorization tokens to connect to its respective user's instant messaging instance. The front-end application then verifies 708 whether there is any existing chat associated with the user's instant messaging instance. If so, the chat is retrieved 710, wherein the front-end application attempts to retrieve the full conversation history. If no existing chat is found, the back-end application creates 712 a chat, wherein the back-end application retrieves a list of users from the coaching server 110, determines the participants to the chat, and creates a chat on the communication server 130 with the participants. In either case, the chat conversation is then displayed 714 within the interface of the coaching software. The back-end application then monitors the chat for messages exchanged, and synchronizes 716 the messages with the chat of the communication server 130, after which the process terminates 718.

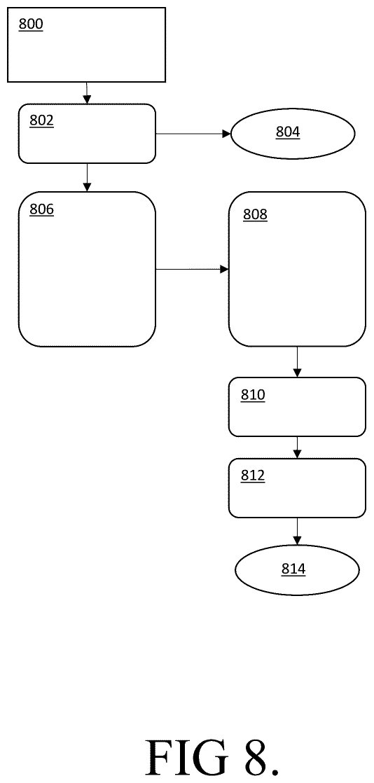

As shown in FIG. 8, the system server 120 may be configured to retrieve 800 a list of all chats associated with an activity or form, of a specific user, when the user interacts with an element of the coaching software. This causes the front-end application of the system server 120 to communicate with the communication server 130 to launch 802 sign-in validation. If the sign-in is cancelled, the process ends 804. Otherwise, the front-end application carries out steps 806, including determining and managing validation tokens as stored on the coaching server 110, validating the tokens and acquiring authorization tokens from the communication server 130, and using the authorization tokens to connect to its respective user's instant messaging instance. The back-end application then carries out steps 808, including providing a list of all chat identifiers associated with the form, in which the user is a participant. The chat identifiers are used to retrieve chat metadata and determine a list of all chats available, in order to provide a list of chats to the user to select. When a chat is selected 810, the system server 120 uses the authorization token and chat identifier to retrieve the full conversation from the communication server 130, which is then displayed within the coaching software. The back-end application then monitors the chat for messages exchanged, and synchronizes 812 the messages with the chat of the communication server 130, after which the process terminates 814.

In some embodiments, the system server 120 may be configured to facilitate other functionality, such as sending 900 adaptive cards or tiles as notifications and/or suggested actions between the coaching server 110 and the communication server 130. In such an embodiment, the process may initiate when an event is triggered 902 in the coaching software of the coaching server 110. The system server 120 then verifies 904 if a chat exists between a user associated with the event, and a bot program of the system server 120. If no existing chat is located, the system server 120 uses the user's credentials stored on the coaching server 110, such as the user's e-mail address, to retrieve 906 associated credentials stored on the communication server 130, such as contact information. The system server 120 then installs 908 the bot in the user's video conferencing software instance. The bot then creates a new chat between the user and itself. If an existing chat is located, the bot instead connects 910 to the chat. In either case, the bot then sends 912 a customized adaptive card to the chat as a notification and/or suggested action, the adaptive card including options which can be selected by the user. The user then selects 914 one or more options, which is received by the bot and is processed by the system server 120. Examples of options include links for navigation 916 within the coaching software of the coaching server 110, fields for making changes 914 to forms in the coaching software related to data stored on the coaching server 110, and sending additional notifications 918 through the video conferencing software chat. If no further options are selected, then the process terminates 922.

While the foregoing is directed to aspects of the present disclosure, other and further aspects of the disclosure can be devised without departing from the basic scope thereof.

1. A computer system for video conference analysis, the computer system comprising:
a coaching server, configured to store data associated with one or more users, including a user name and a user role identifier being at least one of a worker and a coaching staff member;
a communication server configured to host communications between the one or more users; and
a system server, including a processor configured to interface between the coaching server and the communication server,
wherein the system server processor is configured to retrieve assignment information between at least one of the one or more coaching staff member users and one or more of the worker users, and
wherein the system server processor is configured to perform a first interfacing task comprising retrieving information from the coaching server and engaging with an application programming interface of the communication server in order to initiate an event based on the retrieved assignment information.

2. The computer system according to claim 1, wherein the stored data for worker users further comprises coaching data.

3. The computer system according to claim 2, wherein the coaching data includes one or more of one or more key performance indices and one or more coaching metrics associated with each of the plurality of worker users.

4. The computer system according to claim 1, wherein the coaching server further comprises a coaching server processor for processing the stored data.

5. The computer system according to any one of claim 1, wherein the communication server is further configured to store video conference user data for the one or more users.

6. The computer system according to any one of claim 1, wherein the communication server further comprises a video conferencing processor configured to host video conferences between the one or more users.

7. The computer system according to any one of claim 1, wherein the information retrieved from the coaching server includes the user name and the user role identifier.

8. The computer system according to any one of claim 1, wherein the system processor is further configured to perform a second interfacing task comprising retrieving information from the communication server, processing the information, and providing the processed information to the coaching server.

9. The computer system according to claim 8, wherein the retrieved information includes a transcript of a video conference held between two or more users, and the stored user data associated with the two or more users which held the video conference.

10. The computer system according to claim 8, wherein the system server processor is further configured to communicate with the communication server to monitor for termination of a video conference in order to trigger the second interfacing task.

11. The computer system according to claim 8, wherein the second interfacing task further comprises requesting and receiving information of a video conference held between two or more users, and processing the video conference information.

12. The computer system according to claim 11, wherein processing the video conference information further comprises extracting text from a transcript of the video conference, assigning user identity information to the sections of the transcript, and formatting the information in a manner suitable for delivery to the coaching server.

13. The computer system according to claim 12, wherein processing the video conference information further comprises analyzing the extracted text in order to identify one or more of a promise, an observation, assessment, commitment and a challenge for the two or more users.

14. The computer system according to claim 13, wherein the second interfacing task further comprises sending the identified user commitments to the coaching server, the coaching server further configured to store the identified user commitments as data associated with the one or more users which held the video conference.

15. The computer system according to claim 14, wherein the computer system is further configured to trigger a subsequent video conference based on an identified user commitment.

16. The computer system according to any one of claim 1, wherein the coaching server is a server for a coaching management software for contact center staff, and the communication server is a server for a video conferencing platform.

17. The computer system according to claim 3, wherein the coaching server is further configured to process key performance indices data for worker users and generate a notification for a worker user and a coaching staff member user associated with the worker user when key performance indices data falls below a predetermined threshold.

18. The computer system according to any one of claim 1, wherein the coaching server is further configured to instruct the system server to initiate a video conference event.

19. The computer system according to any one of claim 1, wherein the system server processor is further configured to:
provide user data to the communication server in order to initiate a video conference event, to send a notification to the users associated with the video conference event, to monitor entry of all users associated with the video conference event into the video conference event, and to monitor the video conference event to determine when the video conference event concludes.

20. The computer system according to claim 12, wherein system server processor is further configured to processes the transcript text to assign a user identifier and time stamp.

21. The computer system according to claim 12, wherein system server processor is further configured to process the transcript text and to identify sections of the text as important.

22. The computer system according to claim 8, wherein system server is further configured to display the processed information on a graphical user interface, and is further configured to receive a user selection from the graphical user interface to select information from the text transcript and associating one or more of a promise, a commitment and a challenge with a user.

23. The computer system according to claim 8, wherein system server is further configured to sends the processed information to the coaching server for storage onto a database.

24. The computer system according to claim 23, wherein the system server is further configured to retrieve the processed information stored on the database of the coaching server, to display the processed information on a graphical user interface, and to receive a user selection from the graphical user interface to amend the processed information, wherein the amended processed information is updated on the database and stored on the coaching server.

25. The computer system according to claim 8, wherein system server is further configured to display the processed information on a graphical user interface, and is further configured to receive a user selection from the graphical user interface to navigate through the processed information based on a selection criterion.

26. The computer system according to claim 25, wherein the selection criterion comprises one or more of a timestamp, a user, or a keyword.

27. The computer system according to claim 24, wherein the coaching server is further configured schedule a video conference based on the amended processed information.

28. The computer system according to claim 8, wherein the communication server is further configured to display the processed information on a graphical user interface, and the system server is further configured to receive a user selection from the graphical user interface to select information from the text transcript and associating one or more of a promise, a commitment and a challenge with a user.

29. A method for video conferencing analysis comprising the steps of:
requesting and retrieving, including monitoring, by a processor, for the termination of a video conference on a video conferencing platform through an application programming interface hook, requesting, by a processor, from a communication server, a file containing a transcript of the video conference, and receiving, by a processor, from the communication server, the file containing the transcript of the conversation between one or more participants of the video conference;
parsing, by a processor, the file containing the transcript of the conversation of the video conference to identify the one or more participants in the video conference, dividing the transcript into fragments, and assigning time stamps to each of said fragments;
processing, including conducting, by the processor, further processing of the transcript of the video conference such that the transcript information is in a format comprehensible by a coaching server;
forwarding, including forwarding the processed transcript of the video conference to a coaching server; and
entering the processed transcript of the video conference into the coaching server.

30. The method according to claim 29, wherein the processing step further includes aligning, by a processor, portions of the transcript of the video conference according to each of the one or more participants in the video conference.

31. The method according to claim 30, wherein the processing step further includes appending, by a processor, time stamps to each portion of the transcript of the video conference.

32. The method according to claim 31, wherein the processing step further includes analyzing, by a processor, the transcript of the video conference to identify information according to predetermined criteria.

33. The method according to claim 32, wherein the predetermined criteria include keywords associated with coaching objectives.

34. The method according to claim 29, wherein the processing step further includes identifying, by the processor, actions, such as commitments, promises, or actionable items communicated by the one or more participants of the video conference.

35. The method according to claim 34, wherein the forwarding step further comprises sending the processed transcript of the video conference, including identified actions, to the coaching server.

36. The method according to claim 29, wherein the forwarding step further comprises sending the transcript with modifications embedded within the transcript.

37. The method according to claim 29, wherein the forwarding step further comprises sending a separate document containing the modifications, and the coaching server further processes the transcript of the video conference.

38. The method according to claim 35, wherein the entering step further comprises entering identified actions associated with one or more of the participants.

39. The method according to claim 38, wherein the method further comprises the step of monitoring coaching outcomes, wherein the coaching server compares identified actions for one or more of the participants to evaluate participants.
